(19) United States
(12) Patent Application Publication
(10) Pub. No.: US 2024/0360864 A1
(43) Pub. Date: Oct. 31, 2024

(54) NUT CAP FOR DIFFERENT NUT SIZES

(71) Applicant: Pacific Injection Molding Ltd., Abbotsford (CA)

(72) Inventor: Lance Nadeau, Abbotsford (CA)

(73) Assignee: Pacific Injection Molding Ltd., Abbotsford (CA)

(21) Appl. No.: 18/327,442

(22) Filed: Jun. 1, 2023

(30) Foreign Application Priority Data
Apr. 26, 2023 (CA) 3198272

(51) Int. Cl. F16B 37/14

(52) U.S. Cl. CPC F16B 37/14

(57) ABSTRACT

A protective nut cap having an interior polygonal surface accommodates different sizes of nuts. Each inner wall of the nut cap has one or more grooves or bends. The nut cap fits over a first sized nut with the nut's walls adjacent to one of the nut cap's inner walls. The nut cap alternatively fits over a second smaller sized nut with the nut cap rotated and each of the smaller sized nut's walls at an angle to the nut cap's inner walls.

### FIELD OF THE INVENTION

This invention is in the field of protective caps for nuts, and more specifically, protective caps for different sizes of nuts.

### BACKGROUND

Street light poles and traffic poles contain nuts at their base to secure the poles to the ground's surface. Such nuts are typically made of metal, and come in a variety of sizes and shapes.

The interface between the nuts and the light pole base, as well as the nuts themselves, are particularly vulnerable. The nuts are constantly exposed to the elements, including rain and snow, making them susceptible to rust and oxidation. Additionally, the small spacing between the nuts and the light pole base can serve to trap moisture, making the threads of the bolt and the light pole base susceptible to rust and oxidation as well.

Protective caps (sometimes referred to as nut caps or nut covers) serve to shield nuts from being exposed to the elements year-round. They also serve a decorative purpose, by concealing the nut and covering any potentially protruding threads. Additionally, protective caps can function to deter tampering with the nut and the light pole.

However, given the variety that exists in the shapes and sizes of nuts, buyers can easily find themselves purchasing protective caps that are incompatible with the nuts used on a given project. For instance, FIGS. 1 and 2 show a standard hex nut 116 (or light duty nut or finished hex nut) and a heavy hex nut 216 (or heavy duty nut) of a nominal size. The standard hex nut 116 is smaller in size compared to the heavy hex nut 216. Nut walls 112 (or sides or flats) on standard hex nut 116 have a smaller width compared to nut walls 212 on heavy hex nut 216.

FIGS. 3-5 show a prior art protective cap 100 having an orifice 106 for standard hex nut 116, and FIGS. 6-8 show a prior art protective cap 200 having an orifice 206 for heavy hex nut 216.

As seen in FIG. 5, the prior art protective cap 100 snugly receives the standard hex nut 116. Base 104 of the prior art protective cap 100 is the correct size and shape for standard hex nut 116. Nut walls 112 of standard hex nut 116 fit against the internal walls 108 of prior art protective cap 100, and edges 114 of standard hex nut 116 fit within internal edges 110 of prior art protective cap 100.

Similarly, the prior art protective cap 200 snugly receives the heavy hex nut 216. Base 204 of the prior art protective cap 200 is the correct size and shape for standard hex nut 216. Nut walls 212 of heavy hex nut 216 fit against the internal walls 208 of prior art protective cap 200, and edges 214 of heavy hex nut 216 fit within internal edges 210 of prior art protective cap 100.

The prior art protective cap 100 is too small for the heavy nut 216, and the prior art protective cap 200 is too large for the small nut 116.

The problem of purchasing a protective cap that does not fit over the particular nuts used is particularly concerning for institutional buyers, such as cities or municipalities, where there may be a need to purchase protective caps for a large amount of nuts that can include a range of different sizes and shapes. For such buyers, the risk of purchasing the incorrect size or shape of protective cap runs high. Incorrect sized protective caps that must be returned to the manufacturer and replaced with correct sized protective caps results in delays, increased shipping costs, and frustration.

The main objective of the present invention is to provide for a protective covering that can fit onto more than one nut size to lower the risk of a purchaser acquiring a protective cap that is incompatible with the nuts used, such as at the base of a light pole.

### SUMMARY OF THE INVENTION

The present invention is a protective cap for that can accommodate different sizes of nuts. Each inner walls of the protective cap have one or more grooves or bends. A first sized nut can snugly fit within the protective cap with each of the nut's walls adjacent to one of the protective cap's inner walls. Alternatively a second smaller sized nut can snugly fit within the protective cap with each of the smaller sized nut's walls at an angle to the protective cap's inner walls.

In one aspect, the invention is a nut cap capable of covering at least two sizes of nuts. The nut cap comprises an interior polygonal surface having n sides and n corners. Each side begins at a first corner and terminates at a second corner spaced apart from the first corner in a clockwise direction. Each of the n sides has a groove located a distance x from the first corner. The interior polygonal surface may be a hexagon or an octagon.

In another aspect, the invention is a nut cap for covering nuts. The nut cap comprises an interior polygonal surface having n cap sides, n cap corners, and n grooves. Each of the n grooves are located on one of the n cap sides. The nut cap fits over a first nut having n first nut corners such that each of the n first nut corners is adjacent to one of the n cap corners when the nut cap is fitted over the first nut. The nut cap fits over a second nut smaller in size than the first nut, the second nut having n second nut corners such that each of the n second nut corners is adjacent to one of the n grooves when the nut cap is fitted over the second nut. The interior polygonal surface may be a hexagon or an octagon.

In another aspect, the invention is a nut cap for covering nuts, the nut cap comprising an interior polygonal surface having 2n cap sides, n cap inner corners, and n cap outer corners. The nut cap fits over a first nut having n first nut corners such that each of the n first nut corners is adjacent to one of the n cap outer corners when the nut cap is fitted over the first nut. The nut cap fits over a second nut smaller in size than the first nut, the second nut having n second nut corners such that each of the n second nut corners is adjacent to one of the n cap inner corners when the nut cap is fitted over the second nut.

In a further aspect, each of the n cap inner corners is equidistant from the nearest two of the n cap outer corners and each of the 2n cap sides are equal in width.

### DESCRIPTION OF THE DRAWINGS

While the invention is claimed in the concluding portions hereof, example embodiments are provided in the accompanying detailed description which may be best understood in conjunction with the accompanying diagrams where like parts in each of the several diagrams are labeled with like numbers, and where:

FIG. 1 is a perspective view of a standard hex nut;

FIG. 2 is a perspective view of a heavy hex nut;

FIG. 3 is a perspective view of a prior art protective cap for a standard hex nut;

FIG. 4 is a bottom view of the prior art protective cap shown in FIG. 3;

FIG. 5 is a bottom view of the prior art protective cap shown in FIG. 3 with the standard hex nut of FIG. 1;

FIG. 6 is a perspective view of a protective cap for a heavy hex nut;

FIG. 7 is a bottom view of the prior art protective cap shown in FIG. 6;

FIG. 8 is a perspective view of the prior art protective cap shown in FIG. 6 with the standard hex nut of FIG. 2;

FIG. 9 is a perspective view of a light pole base;

FIG. 10 is a bottom perspective view of a protective cap according to one embodiment of the invention;

FIG. 11 is a bottom view of the protective cap show in FIG. 10;

FIG. 12 is a bottom view of the protective cap shown in FIG. 10 with the standard hex nut of FIG. 1;

FIG. 12A is a cross-sectional view of the protective cap shown in FIG. 10 with the standard hex nut of FIG. 1 and a bolt;

FIG. 12B is a cross-sectional view of the protective cap shown in FIG. 10 with the standard hex nut of FIG. 1 and a bolt, taken along line 12B-12B of FIG. 12A;

FIG. 13 is a bottom view of the protective cap shown in FIG. 10 with the heavy hex nut of FIG. 2;

FIG. 13A is a cross-sectional view of the protective cap shown in FIG. 10 with heavy hex nut of FIG. 2 and a bolt;

FIG. 13B is a cross-sectional view of the protective cap shown in FIG. 10 with the heavy hex nut of FIG. 2 and a bolt, taken along line 13B-13B of FIG. 13A;

FIG. 14 is a bottom view of a protective cap according to a second embodiment of the invention;

FIG. 15 is a bottom view of the protective cap of FIG. 14 with a large octagon nut;

FIG. 16 is a bottom view of the protective cap of FIG. 14 with a medium octagon nut;

FIG. 17 is a bottom view of the protective cap of FIG. 14 with a small octagon nut;

FIG. 18 is a bottom view of the protective cap of FIG. 14 with a square nut;

FIG. 19 is a bottom perspective view of a protective cap according to a third embodiment of the invention;

FIG. 20 is a bottom view of the protective cap shown in FIG. 19;

FIG. 21 is a bottom view of the protective cap shown in FIG. 19 with the heavy hex nut of FIG. 2; and

FIG. 22 is a bottom view of the protective cap shown in FIG. 19 with the standard hex nut of FIG. 1.

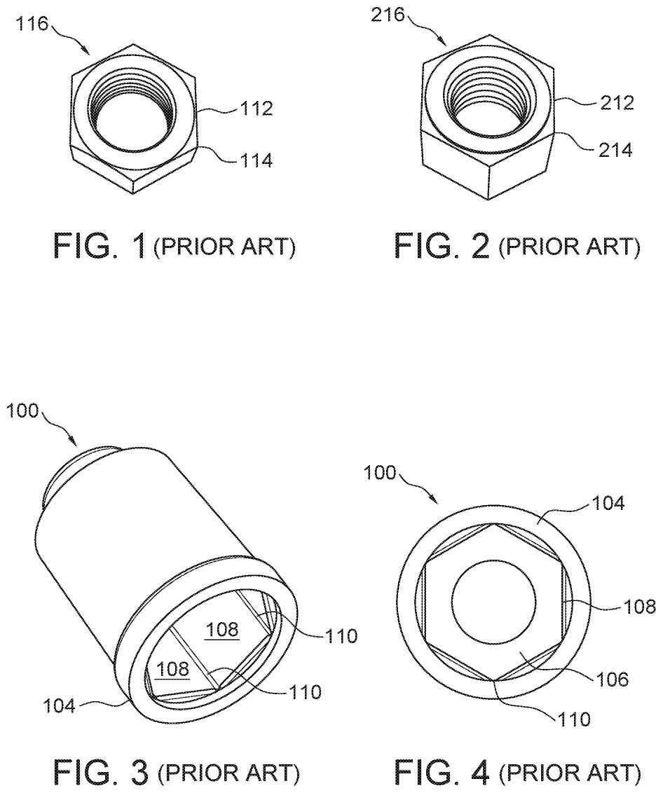

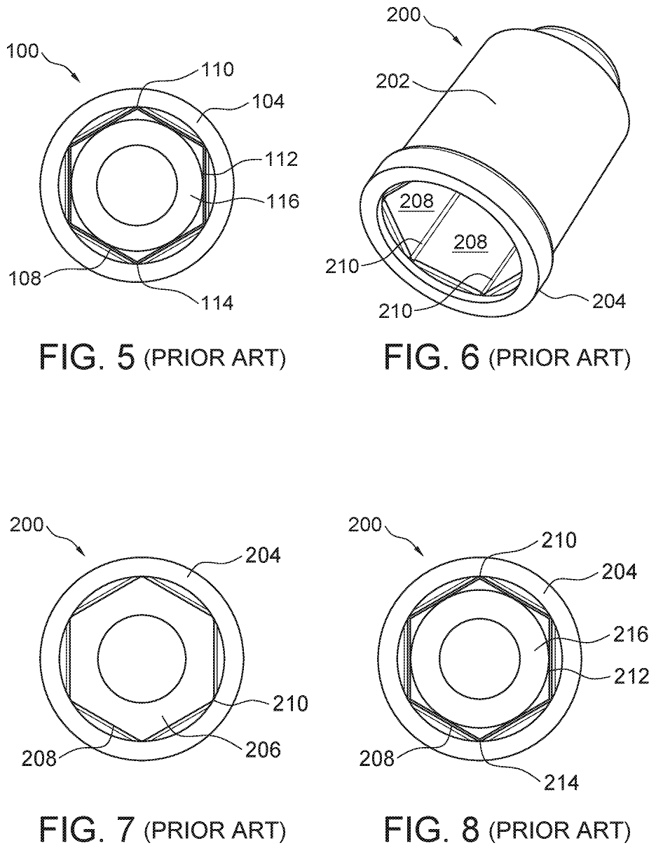

### DETAILED DESCRIPTION OF THE ILLUSTRATED EMBODIMENTS

Illustrative embodiments of the invention are described below. The following explanation provides specific details for a thorough understanding of and enabling description for these embodiments. One skilled in the art will understand that the invention may be practiced without such details. In other instances, well-known structures and functions have not been shown or described in detail to avoid unnecessarily obscuring the description of the embodiments.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list. When the word “each” is used to refer to an element that was previously introduced as being at least one in number, the word “each” does not necessarily imply a plurality of the elements, but can also mean a singular element.

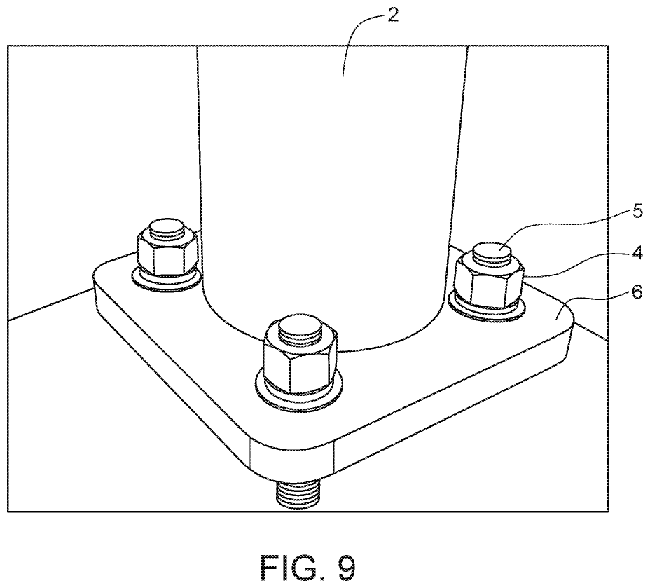

FIG. 9 shows the bottom of a light pole 2 containing nuts 4 and bolts 5 to secure the base 6 of the light pole 2 to the ground. The nuts 4 and bolts 5 are shown as uncovered and exposed. Other light poles 2 can contain a different number of nuts 4 and bolts 5, and could utilize nuts 4 and bolts 5 in a variety of shapes and sizes.

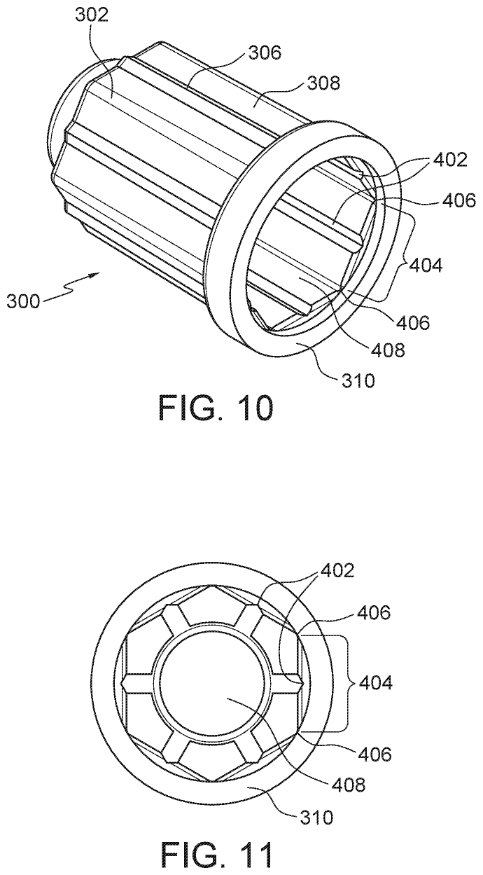

FIGS. 10-13B collectively show several views of a protective cap 300 according to a preferred embodiment of the present invention. The protective cap 300 contains an orifice 408 in which at least two sizes of nuts may fit. When placed over a nut 4 at the base of a light pole, the base 310 will be positioned closest to the ground.

The internal surface of the protective cap 300 contains several features. The internal walls 404 contain both internal edges 406 and internal grooves 402.

The internal walls 404 are of equal length to one another, and are positioned at an angle depending on the number of internal walls. The internal edges 406 are found at each end of each of the internal walls 404, in that the internal walls 404 are separated from one another by an internal edge 406 that extends upwards to form orifice 408.

Internal grooves 402 are located along each internal wall 404, running parallel to the internal edges 406. For instance, the internal grooves 402 may be placed on each internal wall 404 equidistant from each adjacent internal edge 406. Alternatively, the internal grooves 402 can be placed at another point along each internal wall 404 closer to one internal edge 406 than another internal edge 406. Internal grooves 402 create a slight cavity along the length of each of the internal walls 404. A person skilled in the art may will appreciate that rather than internal grooves 402, other structures to create or form a gap or break in internal wall 404 may be used, including but not limited to depressions, cavities, cut-outs, or troughs along the length of each internal wall.

The number of internal edges 406 and internal grooves 402 may vary, as they will correspond to the shape of the respective nut and the number of sides it has. For instance, if the protective cap is made to fit overtop a six-sided nut, the protective cap will have six internal edges and six internal grooves to accommodate the nut as shown in FIGS. 10-13B. Alternatively, if the protective cap is made to fit overtop an eight-sided nut, it will have eight internal edges and eight internal grooves to accommodate the nut. The number of internal edges 406 is generally equal to the number of internal walls 404.

As the external surfaces of the protective cap 300 do not engage the nut, such external surfaces can vary in appearance and configuration. For instance, protective nut cap 300 may have a round external surface. Alternatively, protective nut cap 300 may have an external surface having the same number of sides as the number of internal walls 404.

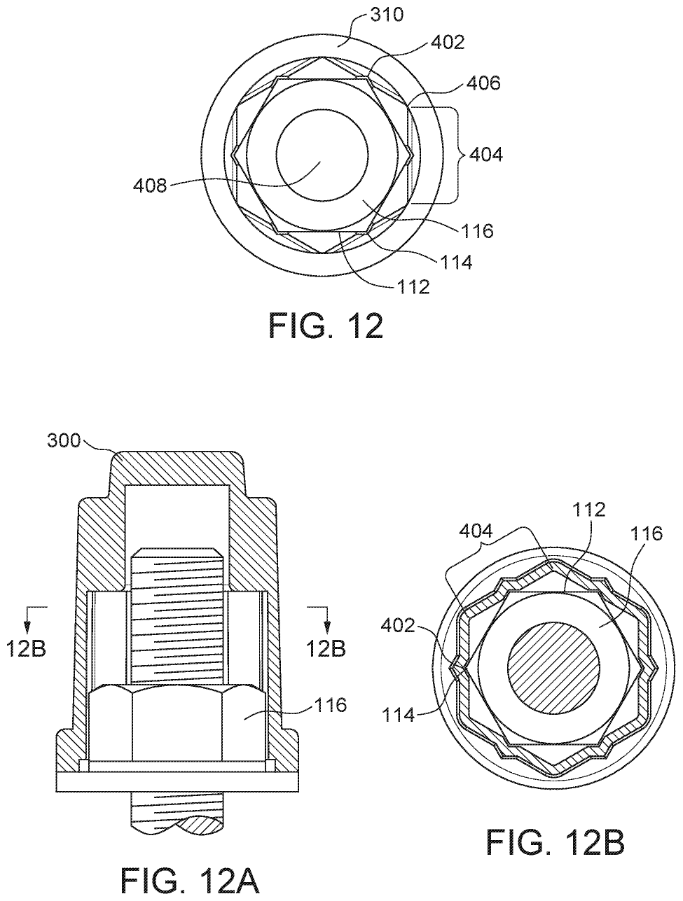

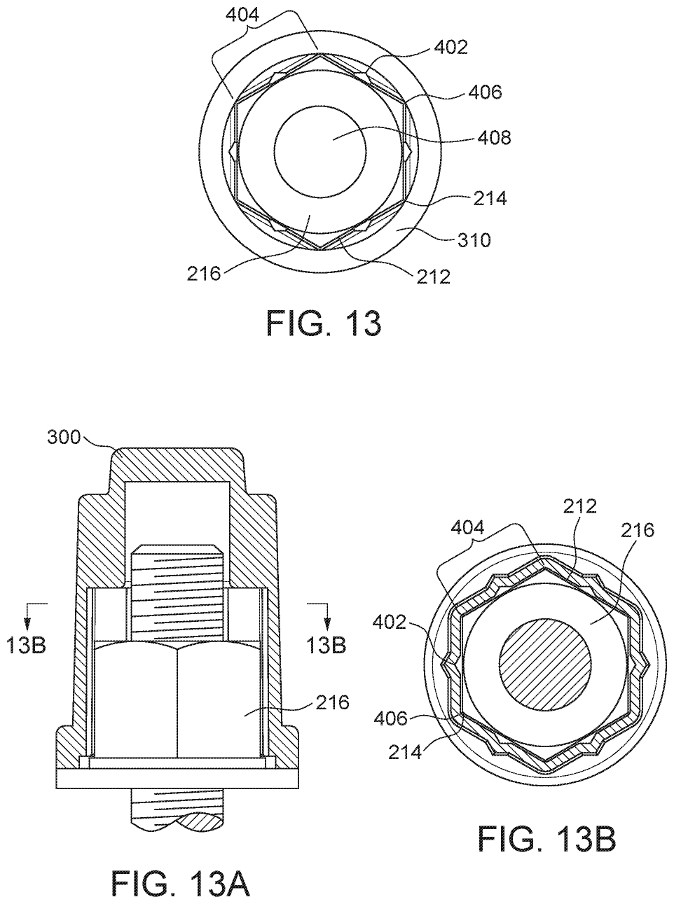

As shown FIGS. 12, 12A, 12B, 13, 13A, and 13B, protective cap 300 fits over at least two sizes of nuts. If positioned overtop a standard hex nut 116, the edges 114 of standard hex nut 116 will fit within the internal grooves 402, which snugly holds the protective cap firmly on the nut. Walls 112 of the standard hex nut 116 will therefore not be in contact with the internal walls 404 within the orifice 408.

If protective cap 300 is positioned overtop a heavy hex nut 216, the walls 212 of heavy hex nut 216 will fit against the protective cap internal walls 404, and the large nut edges 214 will fit within the protective cap internal edges 406, holding the protective cap firmly on the nut. The protective cap internal grooves 402 are therefore unused when the protective cap is placed overtop a heavy hex nut 216.

During use, if a user is installing protective cap 300 over nut 4 but the user is uncertain whether nut 4 is a standard hex nut 116 or a heavy hex nut 216, the user would simply try fitting protective cap 300 in a first orientation. If the protective cap 300 did not snugly fit over nut 4, the user could then rotate the protective cap slightly in a clockwise or counter clockwise direction and try fitting protective cap 300 over nut 4 in a second orientation.

The number and configuration of the internal edges 406 and internal grooves 402 along the internal walls 404 may be altered to fit different nut shapes and to accommodate varied nut sizes.

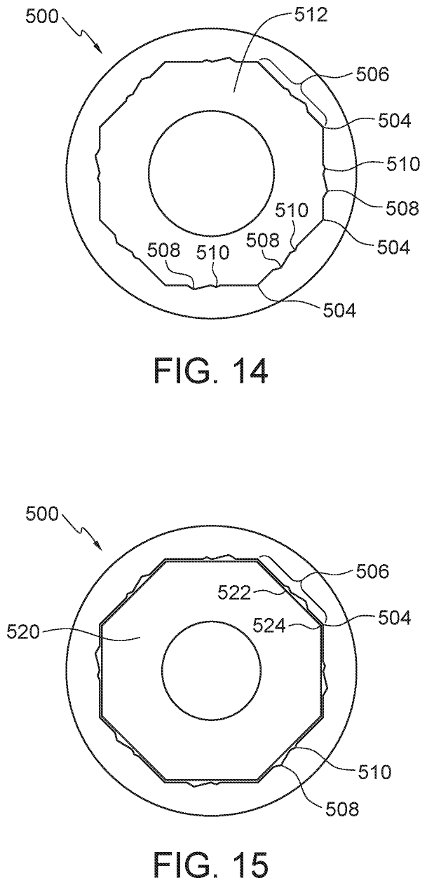

For instance, FIGS. 14 to 18 shows an alternate protective cap 500 having an orifice 512 that is capable of fitting at least three sizes of nuts. In this instance, the orifice 512 has eight internal walls 506, eight internal edges 504, eight small internal grooves 510, and eight large internal grooves 508. The small internal grooves 510 may positioned equidistant from each adjacent internal edge 504 and the large internal grooves 508 may positioned between the small internal grooves 510 and the internal edges 504. However, it will be appreciated that alternate positioning of the small internal grooves 510 and large internal grooves 508 is possible.

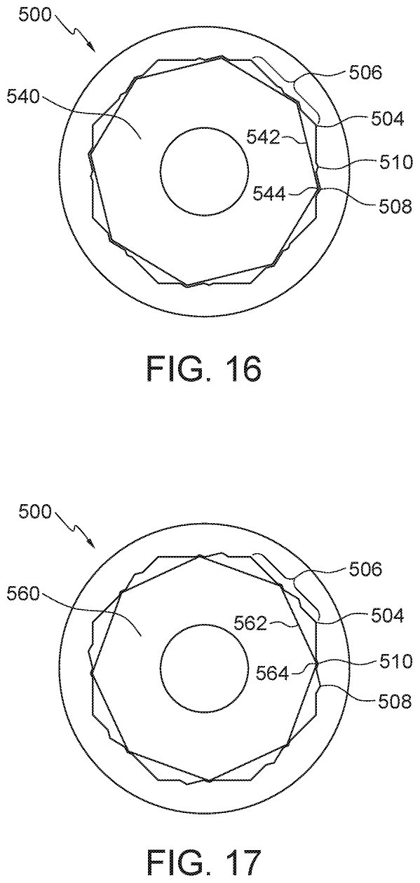

Protective cap 500 can fit a large octagon nut 520 (shown in FIG. 15), a medium octagon nut 540 (shown in FIG. 16), and a small octagon nut 560 (shown in FIG. 17).

As shown in FIG. 15, when protective cap 500 is fitted over a large octagon nut 520, each of the eight walls 522 of the large octagon nut 520 are adjacent and substantially parallel to one of the internal walls 506. Additionally, each of the eight edges 524 of the large octagon nut 520 fit within one of the eight internal edges 504.

As shown in FIG. 16, when protective cap 500 is fitted over a medium octagon nut 540, each of the eight walls 542 of the medium octagon nut 540 are at an angle to each of the internal walls 506. Additionally, each of the eight edges 544 of the medium octagon nut 520 fit within one of the eight large internal edges 508.

As shown in FIG. 17, when protective cap 500 is fitted over a small octagon nut 560, each of the eight walls 562 of the small octagon nut 560 are at an angle to each of the internal walls 506. Additionally, each of the eight edges 564 of the medium octagon nut 560 fit within one of the eight small internal edges 510.

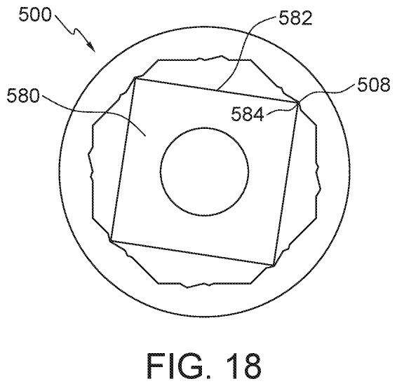

As shown in FIG. 18, protective cap 500 can may also be fitted over a square nut 580 with four walls 582 and four edges 584. Each of the edges 584 of the square nut 580 is shown as fitting within every other large internal groove 508. However, it will be appreciated that the edges of a larger square nut or a smaller square nut could fit within every other internal edge 504 or every other small internal groove 510 respectively.

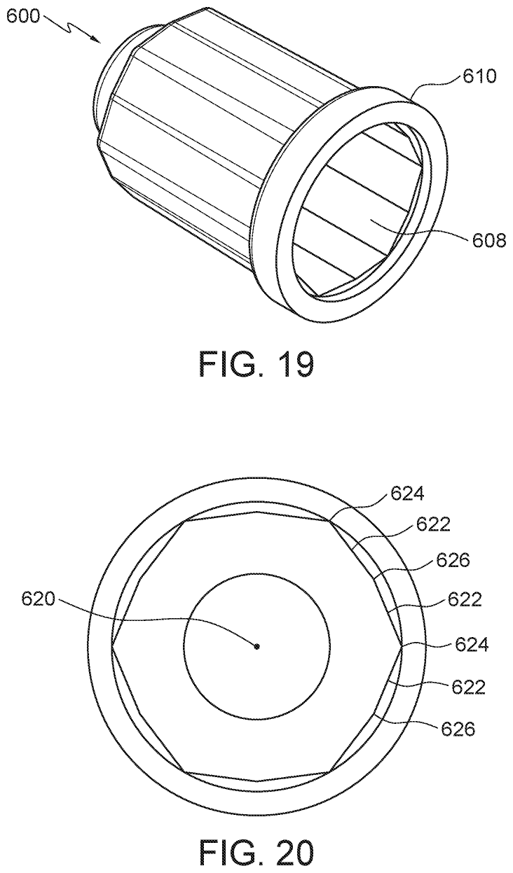

FIG. 19 shows another embodiment of a protective cap 600 that can accommodate more than one size of nut. Protective cap 600 has a base 610 that is positioned closest to the ground when the protective cap 600 is placed over a nut 4 at the base of a light pole. The protective cap 600 has an orifice 608 to receive the nut 4.

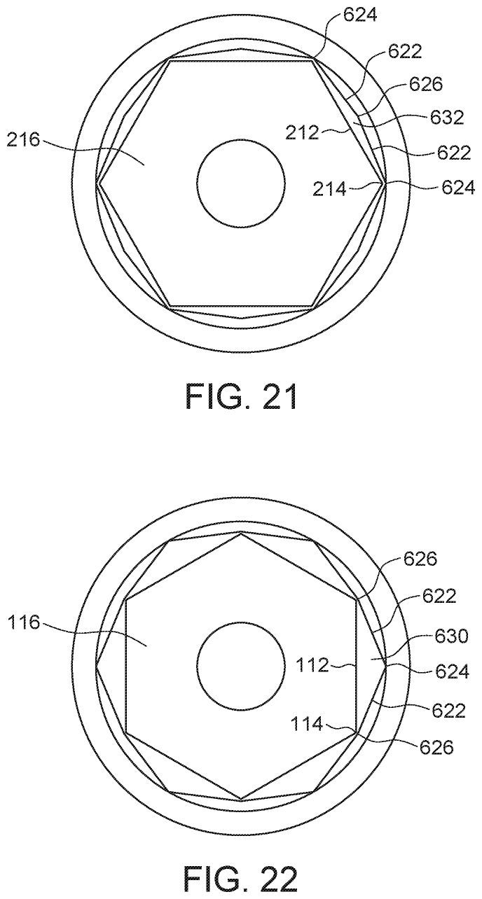

The protective cap 600 can receive a standard hex nut 116 (as shown in FIG. 22) or a heavy hex nut 216 (as shown in FIG. 21). Rather than grooves on internal walls, protective cap 600 has twelve internal walls 622. This is double the six internal walls 404 of protective cap 300. Additionally, protective cap 600 has twelve internal edges, namely six inner edges 626 and six outer edges 624. Outer edges 624 are greater distance away from center 620 of the orifice 608 compared to inner edges 626. Additionally, the internals edges in the orifice 608 alternate between outer edge 624 and inner edge 626.

The internal walls 622 are shown as being of equal length to one another, and are positioned at an angle depending on the number of internal walls. This is because each inner edge 626 is equidistance from the nearest two outer edges 624. It will be appreciated that if each inner edge 626 was closer to one of the nearest two outer edges 624, then rather than twelve equal length internal walls 622, the protective cap 600 would have six internal walls of one length and six internal walls of another length.

At the end of each internal wall 622 is one inner edge 626 and one outer edge 624. Internal walls 622, inner edges 626, and outer edges 624 extend upward into the protective cap 600 to form orifice 408.

The number of inner edges 626 and outer edges 624 may vary, as they will correspond to the shape of the respective nut and the number of sides it has. For instance, if the protective cap is made to fit overtop a six-sided nut, it will have six inner edges 626 and six outer edges 624 to accommodate the nut as shown in FIGS. 19-22. Alternatively, if the protective cap is made to fit overtop an eight-sided nut, it will have eight inner edges 626 and eight outer edges 624 to accommodate the nut.

External surfaces of the protective cap 600 may vary in appearance or configuration. For instance, protective nut cap 600 may have a round external surface. Alternatively, protective nut cap 600 made have an external surface having the same number of sides as the number of internal walls 622.

Protective cap 600 fits over at least two sizes of nuts. As shown in FIG. 21, if protective cap 600 is positioned over a heavy hex nut 216, the edges 214 of heavy hex nut 216 will fit adjacent to outer edges 624, which will hold the protective cap 600 on the nut 216. Walls 212 of the heavy hex nut 216 will not be in contact with inner walls 622 within the orifice 608 except at inner edges 624. A space 632 will exist between each nut wall 212 and the nearest two internal walls 622 of the protective cap 600. The inner edges 626 are unused when the protective cap 600 is placed overtop a heavy hex nut 216.

As shown in FIG. 22, if positioned overtop a standard hex nut 116, the edges 114 of standard hex nut 116 will fit adjacent to inner edges 626, which will hold the protective cap 600 firmly on the nut 116. Walls 112 of the standard hex nut 116 will not be in contact with internal walls 622 within the orifice 608 except at inner edges 626. A space 630 will exist between each nut wall 112 and the nearest two internal walls 622 of the protective cap 600. The outer edges 624 are unused when the protective cap 600 is placed overtop a standard hex nut 116.

During use, if a user is installing protective cap 600 over nut 4 but the user is uncertain whether not 4 is a standard hex nut 116 or a heavy hex nut 216, the user would simply try fitting protective cap 600 in a first orientation. If the protective cap 300 did not snugly fit over nut 4, the user could then rotate the protective cap slightly and try fitting protective cap 600 over nut 4 in a second orientation. For instance, the first orientation may be with inner edges 626 adjacent to the edges of nut 4 and the second orientation may be with outer edges 624 adjacent to the edges of the nut 4.

Protective caps 300, 500, and 600 are preferably made of plastic. However, it will be appreciated that other materials are possible such as metal.

The above detailed description of the embodiments of the invention is not intended to be exhaustive or to limit the invention to the precise form disclosed above or to the particular field of usage mentioned in this disclosure. While specific embodiments of, and examples for, the invention are described above for illustrative purposes, various equivalent modifications are possible within the scope of the invention, as those skilled in the relevant art will recognize. Also, the teachings of the invention provided herein can be applied to other systems, not necessarily the system described above. The elements and acts of the various embodiments described above can be combined to provide further embodiments.

All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

Changes can be made to the invention in light of the above “Detailed Description.” While the above description details certain embodiments of the invention and describes the best mode contemplated, no matter how detailed the above appears in text, the invention can be practiced in many ways. Therefore, implementation details may vary considerably while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated.

While certain aspects of the invention are presented below in certain claim forms, the inventor contemplates the various aspects of the invention in any number of claim forms. Accordingly, the inventor reserves the right to add additional claims after filing the application to pursue such additional claim forms for other aspects of the invention.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

What is claimed is:

1. A nut cap capable of covering at least two sizes of nuts, the nut cap comprising:
an interior polygonal surface having n sides and n corners, each side beginning at a first corner and terminating at a second corner spaced apart from the first corner in a clockwise direction;
wherein each of the n sides has a groove located a distance x from the first corner.

2. The nut cap of claim 1 wherein the interior polygonal surface is a hexagon.

3. The nut cap of claim 1 wherein the interior polygonal surface is an octagon.

4. A nut cap for covering nuts, the nut cap comprising:
an interior polygonal surface having n cap sides, n cap corners, and n grooves, each of the n grooves located on one of the n cap sides;
wherein the nut cap fits over a first nut having n first nut corners such that each of the n first nut corners is adjacent to one of the n cap corners when the nut cap is fitted over the first nut; and
wherein the nut cap fits over a second nut smaller in size than the first nut, the second nut having n second nut corners such that each of the n second nut corners is adjacent to one of the n grooves when the nut cap is fitted over the second nut.

5. The nut cap of claim 4 wherein the interior polygonal surface is a hexagon.

6. The nut cap of claim 4 wherein the interior polygonal surface is an octagon.

7. A nut cap for covering nuts, the nut cap comprising:
an interior polygonal surface having 2n cap sides, n cap inner corners, and n cap outer corners;
wherein the nut cap fits over a first nut having n first nut corners such that each of the n first nut corners is adjacent to one of the n cap outer corners when the nut cap is fitted over the first nut; and
wherein the nut cap fits over a second nut smaller in size than the first nut, the second nut having n second nut corners such that each of the n second nut corners is adjacent to one of the n cap inner corners when the nut cap is fitted over the second nut.

8. The nut cap of claim 7 wherein each of the n cap inner corners is equidistant from the nearest two of the n cap outer corners and each of the 2n cap sides are equal in width.
